(19) United States
(12) Patent Application Publication
(10) Pub. No.: US 2009/0241990 A1
(43) Pub. Date: Oct. 1, 2009

(54) PAINT SCRAPER APPARATUS AND METHOD

(76) Inventors: Neil Stephen Smith, Pittsfield, MA (US); Tristen Garrett Smith, Pittsfield, MA (US)

Correspondence Address: PATE PIERCE & BAIRD, 175 SOUTH MAIN STREET, SUITE 1250, SALT LAKE CITY, UT, 84111, US

(21) Appl. No.: 12/414,855

(22) Filed: Mar. 31, 2009

Related U.S. Application Data
(60) Provisional application No. 61/064,842, filed on Mar. 31, 2008.

(51) Int. Cl. A47L 13/08; B08B 1/00; A47L 13/02

(52) U.S. Cl. 134/6

(57) ABSTRACT

An apparatus and method for scraping paint to prepare surfaces for fresh paint may include two, three, or more independent blades attached to a single handle to provide follow up scraping by parallel edges after the leading edge has passed, in order to improve the effectiveness of scraping. Chips, scratches, and other breaches in one blade need not leave a flaw behind as subsequent blades passing over the surface will lift that material away from the surface. Blades may be configured to be identical, reversible, and interchangeable, providing substantial convenience, durability, and wear.

### RELATED APPLICATIONS

This application claims the benefit of co-pending U.S. Provisional Patent Application Ser. No. 61/064,842, filed on Mar. 31, 2008, incorporated herein by reference.

### BACKGROUND

1. The Field of the Invention

This invention relates generally to hand tools, and, more particularly, to scrapers.

2. The Background Art

Portions of the world and of the United States of America have a combination of temperature extremes and high humidity. Temperature extremes cause cycling between evaporation of moisture and condensation of moisture during the 24 hours of the day. Likewise, with seasonal changes, weather may range from wet, snowy, icy, or the like to sunny and hot.

One consequence of weather, temperature, and moisture is protection of paint and stain required to maintain wood. Periodically, paint must be removed. Meanwhile, underlying layers of previous years must typically be prepared for painting. This may involve scraping. In humid environments, it typically requires removal of layers of paint that have delaminated from the underlying wood. Various mechanisms have been used for the removal of old paint including blow torches, wire brushes, scrapers, and the like. Each approach has its benefits and difficulties.

It would be an advance in the art to provide a scraper that is more effective than conventional scrapers. Whether using a putty knife or a scraper of another type, a user must apply significant downward pressure of a blade against the surface containing paint. The blade must slide along some paint at locations that maintain their integrity and do not remove. By the same token, the blade must penetrate and lift away portions of the paint adhered to the surface. Of course, some paint that is well adhered may still be stripped by a scraper. Nevertheless, it is not uncommon for a user to pass over a surface several times with a scraper blade trying to assure that the paint that should be removed has been removed.

Thus, it would be an advance in the art to provide a paint scraping tool that could reduce the number of passes, and render more effective the scraping of paint. Scrapers may be used in combination with blow torches. Blow torches may help with softening or separating paint from the underlying wood by lifting it away from the surface.

### BRIEF SUMMARY OF THE INVENTION

In view of the foregoing, in accordance with the invention as embodied and broadly described herein, a method and apparatus are disclosed in one embodiment of the present invention as including a scraper tool having multiple, independent, blades. So that all of them operate within the single plane they may be mounted in a frame or handle with parallel edges all acting in a plane. For example, most of the embodiments of such a tool may have two, three, or four blades.

In one embodiment, the apparatus with two or more blades operates with both blades in contact simultaneously with the surface of the scraped material. In an alternative embodiment, the scraper may include many blades spaced from one another such that all of three, four, or more blades may be in contact with a surface at one time. Accordingly, a first blade edge may scrape along the surface, followed by a second blade edge shortly behind, and that of another optional blade therebehind.

Thus, with the device spacing the blades apart, the user may capture by a second, third, or other subsequent blade those portions of loose paint on the surface over which previous blades passed but simply did not remove. For example, if a first blade rides up over a portion of the paint and refuses to lift the paint off the underlying wooden surface, a later blade may pass over that surface and remove it. Likewise, the blade may lift up on one side as a result of variations in surface texture, the paint thickness, or debris. Thus, further away, the blade may rise further and fail to remove paint from the surface. Following blades may still come along be, making better contact with the surface, for example, because they are independent or as a result of having less debris captured thereunder. By not riding up over the same material they may now remove it.

Thus, it has been found that an apparatus and method relying on multiple, independent blades having parallel, coplanar, cutting edges are more effective then a single blade. Such an apparatus seems to perform better than multiple passes with a single blade. It has been found that multiple blades will each take paint material from the surface, and collect it in the space between the blades, discharging it out the sides, and at the end of the stroke.

### BRIEF DESCRIPTION OF THE DRAWINGS

The foregoing features of the present invention will become more fully apparent from the following description and appended claims, taken in conjunction with the accompanying drawings. Understanding that these drawings depict only typical embodiments of the invention and are, therefore, not to be considered limiting of its scope, the invention will be described with additional specificity and detail through use of the accompanying drawings in which:

FIG. 1 is a perspective view of one embodiment of an apparatus having multiple, independent, blades having parallel, coplanar cutting edges in accordance with the invention;

FIG. 2 is a perspective view of a paint scraper apparatus of FIG. 1 illustrating the fastener portion for securement in an exploded configuration to show details;

FIG. 3 is a perspective view of one embodiment of a blade assembly including three blades provided with a central aperture for mounting as well as peripheral apertures for registration on corresponding studs extending from the face of the handle holding the blade assembly;

FIG. 4 is a perspective view of an alternative embodiment of a blade assembly in which each blade is identical to the other blades, and may be nested with one or more other blades, while also being reversible, thus providing durability, replaceability, and reduction of inventory parts by requiring only a single blade configuration;

FIG. 5 is a perspective view of one embodiment of a scraper in accordance with the invention mounting the blade assembly of FIG. 4 on a handle suitable for scraping the apparatus over a surface;

FIG. 6 is a side-elevation view of one embodiment of a blade assembly in accordance with the invention;

FIG. 7 is an alternative embodiment of a blade assembly in accordance with the invention, in which the blades are not double ended;

FIG. 8 is a side elevation view of an alternative embodiment of a blade assembly corresponding to the scraper of FIGS. 4 and 5, and illustrating a system of aperture lobes that restrain the individual blades to operate together at a distinct spacing, while still maintaining one, two, or more blades to be accumulated together, and ye all may be identical shape and size;

FIG. 9 is a bottom plan view of the blade assembly of FIG. 6;

FIG. 10 is a bottom plan view of the blade assembly of FIG. 8;

FIG. 11 is a bottom plan view of one embodiment of a scraper in accordance with the invention;

FIG. 12 is a top plan view thereof;

FIG. 13 is a front end elevation view thereof;

FIG. 14 is a rear end elevation view thereof;

FIG. 15 is a right side elevation view thereof; and

FIG. 16 is a left side elevation view thereof.

### DETAILED DESCRIPTION OF THE PREFERRED EMBODIMENTS

It will be readily understood that the components of the present invention, as generally described and illustrated in the drawings herein, could be arranged and designed in a wide variety of different configurations. Thus, the following more detailed description of the embodiments of the system and method of the present invention, as represented in the drawings, is not intended to limit the scope of the invention, as claimed, but is merely representative of various embodiments of the invention. The illustrated embodiments of the invention will be best understood by reference to the drawings, wherein like parts are designated by like numerals throughout.

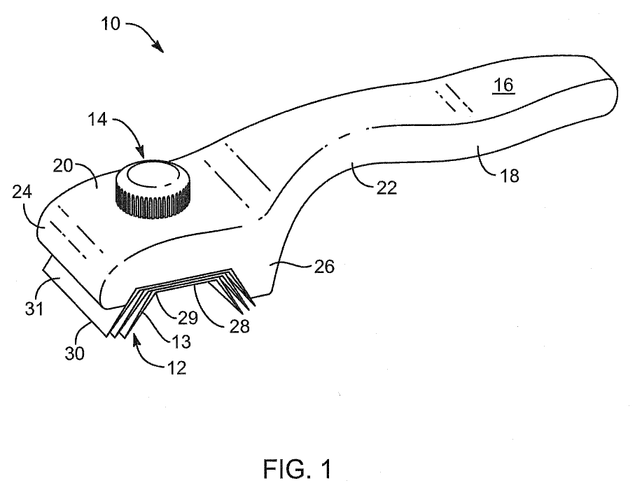

Referring to FIG. 1, an apparatus 10 in accordance with the invention, may include a blade assembly 12 comprising one, two, three, or more blades 13 secured together. The blade assembly 12 may be made as a unitary, integrated component. In alternative embodiments, the blade assembly 12 may be made up of distinct pieces as blades 13. In fact, the blades 13 in some embodiments may be identical to one another and interchangeable.

In the illustrated embodiment the blades 13 may have active edges and inactive edges. The active edges are those at the front of the scraper and exposed to the surface being scraped. Meanwhile, the inactive edges are further back along apparatus 10 and may be simply held as replacements.

A securement 14 may connect to penetrate through the blade assembly 12 to hold the blades 13 in place in the apparatus 10. The securement 14 may pass through a handle 16 to secure the blade assembly 12 to the handle 16 held by a user. The handle 16 may include a grip 18 or grip portion 18 adapted to be grasped securely in the hand of a user.

The grip 18 may be provided with knurling a soft elastomeric coating, a narrow portion and a wider portion, or multiple narrow and wide portions, or the like in order to improve over friction as the exclusive mechanism for securing a user's hand on the grip 18. Finger rests, a central expansion of the body of the grip 18, and the like may provide additional application of force by a user in pushing the scraper forward and backward, rendering more force available for scraping.

A grip 18 may be connected to a foot 20 or foot portion 20 by a knee portion 22. The knee may include a bend in order to place the plane of the foot 20 at an angle with respect to the plane of the grip 18. In other embodiments, the grip 18 and foot 20 may actually be formed to extend substantially parallel to a single plane. They may even be in the same plane.

In one embodiment, the foot 20 may include a toe portion 24 serving to register the blade assembly 12, and to support it in at least one dimension. The toe 24 may serve to capture the blade assembly 12 between the heel 26 and the toe 24. For example, the securement 14 may secure the blade assembly 12 to the foot in one direction, say for example, a nominal vertical direction, while the toe 24 and heel 26 secure the blade assembly 12 and support it in a horizontal direction orthogonal thereto.

In one embodiment, the blades 13 may each include a base 28 or base portion that connects across a corner 29 to an extension 31 terminating at an edge 30. For example, a single substrate of metal may be bent to form a base portion 28 and the extension portion 31 distinguished only by the existence of the corner 29 at which the bend is made.

Meanwhile, the operating portion of the blade 32 is the edge 30 that may be sharpened by one of several means. For example, in several embodiments, the blades may be tapered such that they come to an edge, which may then be ground periodically on one or both sides in order to maintain its sharpness. Meanwhile, a tapered extension portion 31 may provide certain advantages including flexibility, a better, sharper edge 30, and the like.

Alternatively, a blade 13 may be formed with a single substrate material having a constant thickness. Accordingly, the edge 30 may be rendered sharp by grinding a chisel-like point or edge 30 that is simply a bevel.

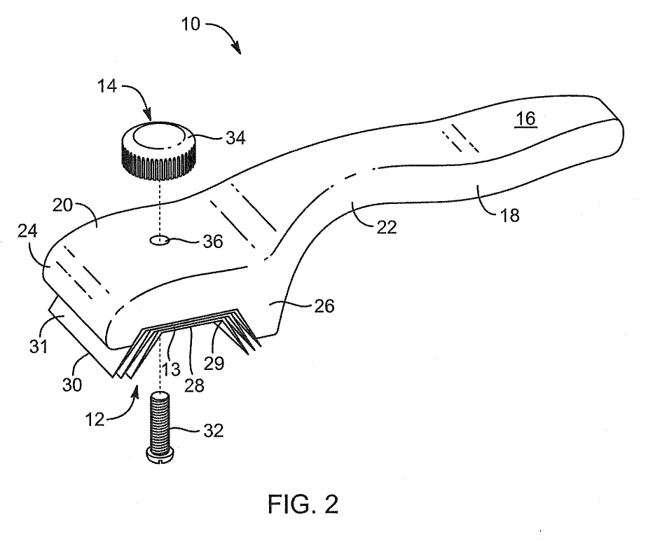

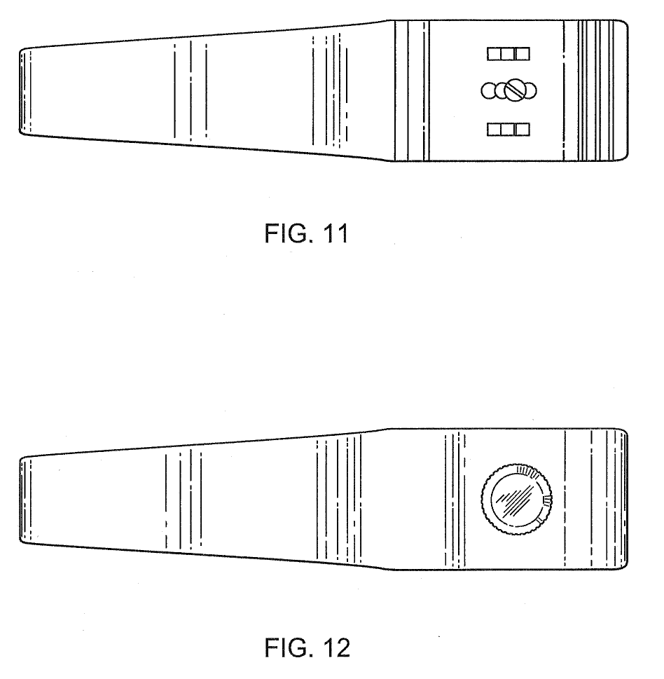

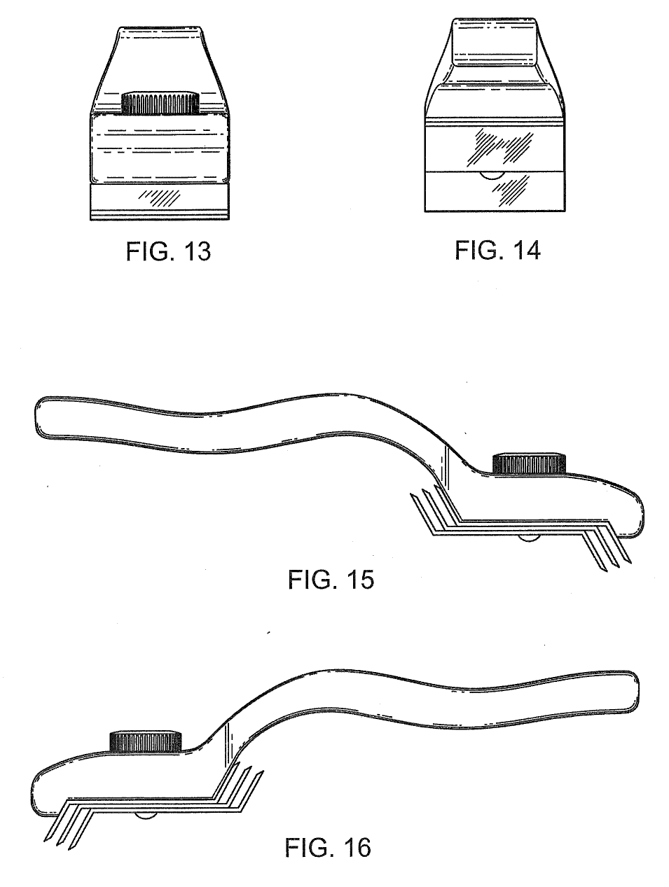

Referring to FIG. 2 while referring generally to FIGS. 1-16, an apparatus 10 may include a fastener 32, penetrating the blade assembly 12, that connects to a retainer 34 through an aperture in the foot 20 of the apparatus 10. A removable fastener 32 may be released by removing a threaded, keyed, twistable, or other form of retainer 34.

In the illustrated embodiment, the fastener 32 is threaded with a thread that mates with a thread inside the retainer 34. In the illustrated embodiment the retainer 34 contains a blind hole that receives the fastener 32. In other embodiments, the retainer 34 may have a through hole, threaded to permit use of a fastener 32 that can be of excessive length and still pass through the retainer 34.

The fastener 32 and retainer 34 may be formed to be of any of the well developed “quick-connect” types in which a single twist or even a fractional turn or a twist may apply pressure, operate a circumferential wedge, or lock in the blade assembly 12 into the foot 20. It is contemplated that any suitable fastener may be used for the securement 14, including clamps, screws, rivets, bayonet fittings, “T” bolts, “T” handles, and so forth as known in the art. In one embodiment, a cam lock such as is used on bicycle axles as a quick disconnect may be used to provide additional pressure holding the blade assembly 12 together and against the foot 20.

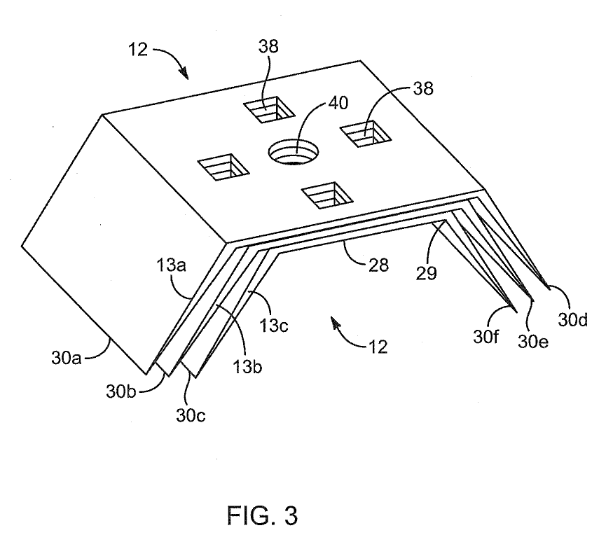

Referring to FIG. 3, while continuing to refer generally to FIGS. 1-16, the blade assembly 12 may include registers 38 or registration apertures 38 into which studs may extend from the surface of the foot 20 to maintain registration of the blades 13. In the illustrated embodiments, four registers 38 or registration apertures 38 may be penetrated by studs extending from the foot 20 in order to maintain the blades 12 in alignment with one another. Thus, the various edges 30a, 30b, 30c, 30d, 30e, 30f may always remain parallel to one another. Meanwhile, the edges 30a-30c may be active, while the edges 30d-30f may be inactive when connected to the foot 20, and any, all, or each may be reversed, one at a time, or all together.

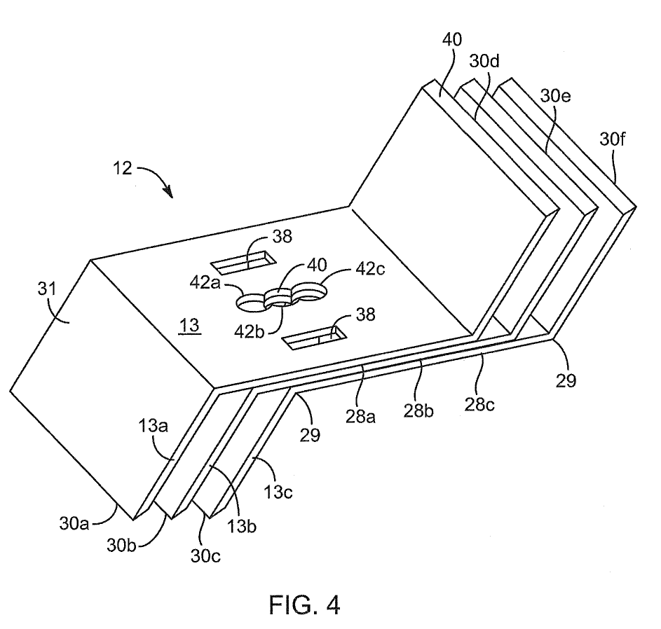

Referring to FIG. 4, while continuing to refer generally to FIGS. 1-16, and particularly comparing with FIG. 3, one may note that the base 28 of each blade 13 may be a unique length or may be of the same length. For example, in the apparatus of FIG. 3, the individual blades 13 are nested in the assembly 12. Accordingly, the corners 29 of each blade 13 may be unique to the size and location of the blade 13. Meanwhile, the extensions 13 for each blade may extend a length suitable to space the edges 30 apart.

In one embodiment, the three edges 30a, 30b, 30c may all operate in a single plane that is not parallel to the bases 28. Thus, the grip 16 may be held at an angle to place the plane defined by the edges 30a, 30b, 30c to work on the surface being scraped. Thus, the edge 30a passes along the surface being scraped, followed by the edge 30b, followed by the edge 30c.

In certain embodiments, the blades 13 may be formed of a particular size, thickness, and angle 48 of the plane of the edges 30 with respect to the base 28 so that the thickness of the base 28 automatically provides the registration and height differentials between the various edges 30a, 30b, 30c, and so forth. Alternatively, spaces may be placed between the individual bases 28a, 28b, 28c in order to offset the edges 30a, 30b, 30c, respectively.

In one embodiment, the aperture 40 may actually be formed with various lobes 42a, 42b, 42c. Accordingly, an offset in a horizontal plane, treating the base 28 as a horizontal plane, may provide preselected spacing between the edges 30a, 30b, 30c. For example, a base 28a may receive a fastener 32 through the lobe 42c. Meanwhile, the base 28b may receive a fastener through the lobe 42b. Meanwhile, the base 28c may receive the fastener through the lobe 42a. Thus, the various lobes 42 provide an offset and retention in place with the proper horizontal spacing between the various extensions 31 of the blades 13.

Referring to FIG. 4, while continuing to refer to FIGS. 1-16, the faces 44 of the blades 13 may be ground to provide a sharp edge 30, as desired. In the illustrated embodiment, the individual blades 13 may be reground until the extensions 31 are so short as to be not useful anymore. Meanwhile, each of the blades 13a, 13b, 13c may be changed in position with any of the other blades 13a, 13b, 13c, or swapped end for end itself. Thus, in any particular location, six edges 30 are candidates for that particular location. One utility of this arrangement is that a leading edge 30a may receive more ware and damage then a trailing edge 30b or 30c. Therefore, at any appropriate time, the blade 13b may be substituted for either of the other two blades. Likewise, the blade 13c may be substituted for either of the other two blades.

If a chip, crack, or other damage occurs along one edge 30, the edges 30 that follow behind it in use may still pick up the ridge that is left by the flaw in the reading edge 30a. Meanwhile, any blade 13 can substitute for any other. Likewise, any blade 13 may be swapped end for end to present a new edge. Thus, a user may assure that by changing positions of the blades, and reversing them at any time, one may always present the best available and sharpest blade at the appropriate location. In fact, in some scenarios, a user may choose to maintain the last edge 30c as the sharpest, while permitting the first edge 30a to take the majority of the abuse and damage.

The embodiment of FIG. 4 may be provided with one or more registers 38 or registration apertures 38 if desired. The registration apertures 38 are optional. For example, the nose 24 and the heel 26 that form the housing that captures the blade assembly 12 may themselves provide support for a back-and-forth horizontal movement of the apparatus 10, as well as resistance to twisting, and the like. By fitting the shape of the foot 20 to capture the blade assembly 12 precisely between the toe 24 and heel 26, rotation of the blades 12 about the securement 14 may be precluded.

In other embodiments, the aperture 20 may be a long rectangular aperture. Thus, the sides of the rectangular aperture, like the registration apertures 38, may resist or preclude rotation. A fastener 32 may have a square shoulder or may be square along all of its length except the threaded portion, if present. In certain embodiments a rectangular fastener 32 may have steps formed in it, which themselves register the horizontal distances of the blades 13, and specifically their bases 28. Thus, various embodiments of an aperture 40 may be used to register the blades 13 with respect to the foot 20.

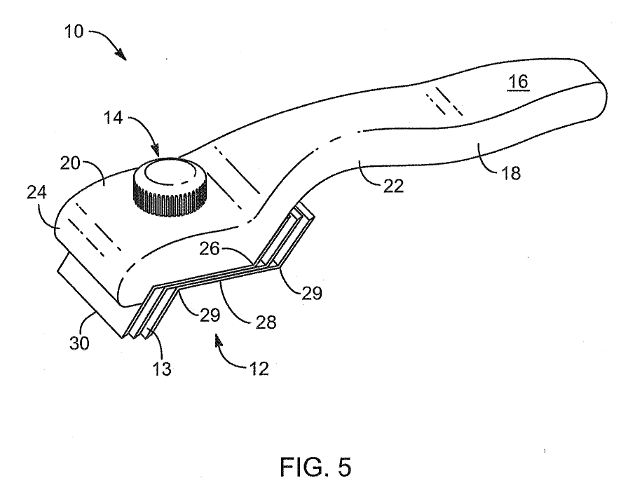

Referring to FIG. 5, the blade assembly 12 may be assembled with a securement 14 against the foot 20. The assembly 12 may or may not be registered against the toe 24, heel 26, or both. In one embodiment, the securement 14 may cinch the blade assembly 12 at its corners 29 against the toe 24 of the foot 20. Likewise, the heel 26 may register at the rear corners 29 of the blades 13 of the blade assembly 12.

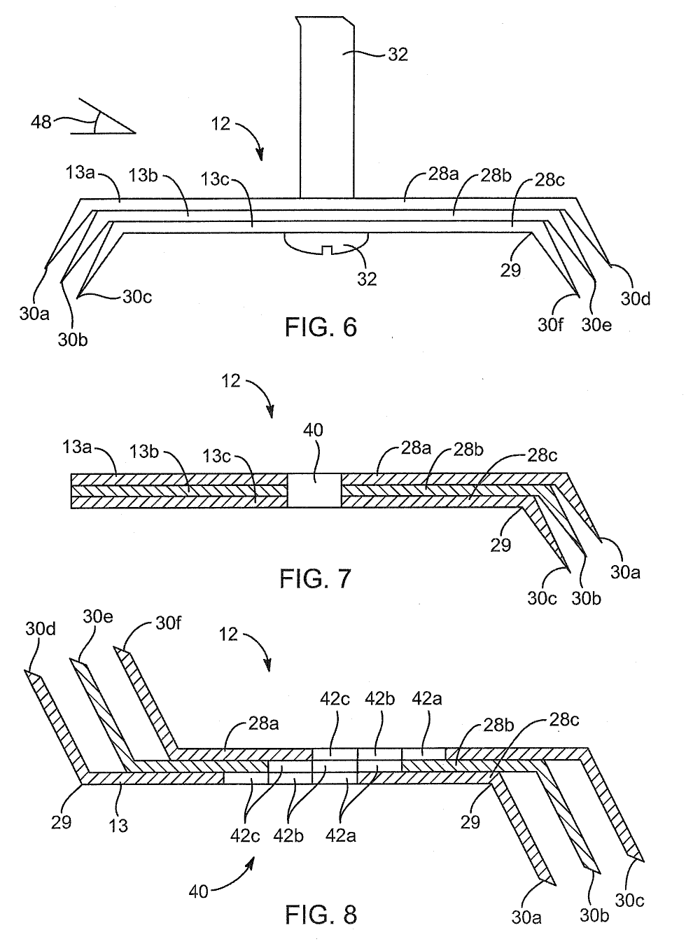

Referring to FIGS. 6-10, while continuing to refer generally to FIGS. 1-16, a blade assembly 12 may be secured together by a fastener 32 of a securement 14. The angle 48 may be dictated by the thickness of the base 28 of each blade 13, or may be dictated by both the thickness of the blade 28, and a spacer placed between one blade 28 and its adjacent blade 28. In the apparatus of FIG. 6, the lower and inner most blade 13c may be shorter in length than the other blades 13a, 13b.

However, in the embodiment of FIG. 7, the lowest blade 13c may be the same length as, or a length different from that of, the other blades 13a, 13b. Again, the angle 48 in the embodiment of FIG. 7 may be dictated by the thicknesses of the various blades 13, or by spacers as well as spacing the blades 13, and thus their respective edges 30 away from one another.

Referring to FIG. 8, the aperture 40 may be configured to have various lobes 42a, 42b, 42c facilitating an offset in horizontal position of the various blades 13 with respect to the securement 14 as well as one another. In the illustrated embodiment, the base 28b in the center of the assembly 12 may receive a fastener 32 through the center lobe 42b. Meanwhile, the uppermost base 28a receives the same fastener 32 through the lobe 42c. Meanwhile, the lowest base 28c receives the fastener 32 through lobe 42a. Thus, the various lobes, here represented as circles that partially encroach on one another, may be configured to support registration of the bases 28 in the blade assembly 12 with a predetermined offset in the horizontal direction.

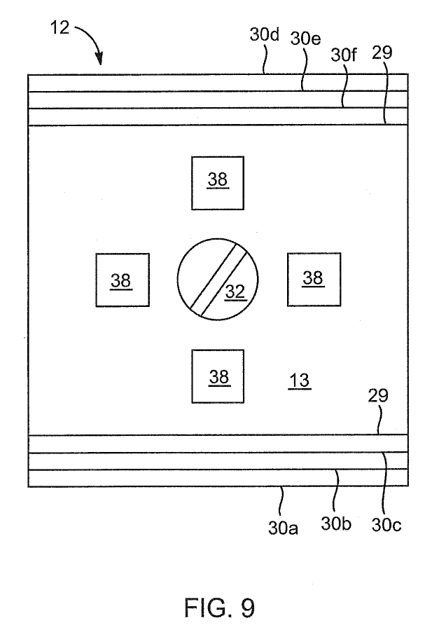

Referring to FIG. 9, the blade assembly 12 showing the head of a fastener 32 and the registration apertures 38 reflects tapered blades having respective edges 30a, 30b, 30c, and opposite edges 30d, 30e, 30f, respectively, at their opposite ends. Meanwhile, the blades 13 are each bent at the appropriate angle at a vertex 29 or corner 29.

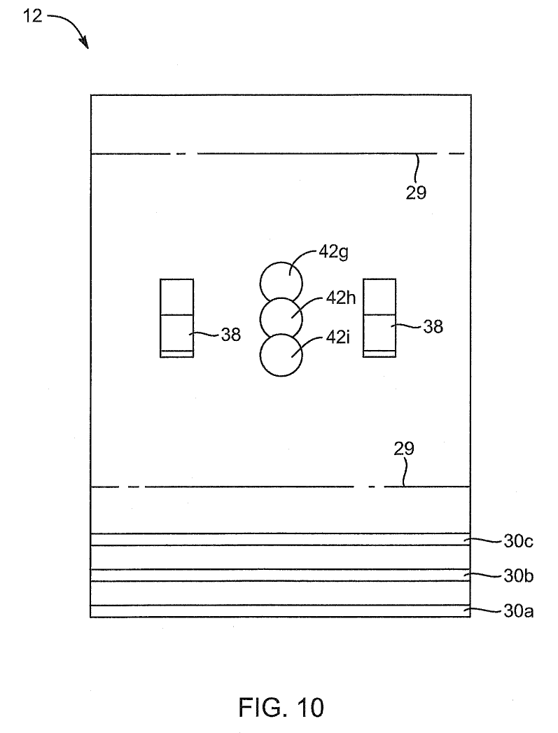

Referring to FIG. 10, the apparatus of FIG. 8 may optionally include registration apertures 38. As illustrated, the lobes 42g, 42h, 42i reflect the offset in the horizontal direction between the various edges 30a, 30b, 30c. Meanwhile, near the edges 30a, 30b, 30c, the corner 29 or vertex 29 is an inside corner 29. Meanwhile, at the opposite end thereof, the corner 29 is an outside corner on the leg 13 corresponding to the edge 30c.

Referring to FIGS. 11-17, the relative proportions of the apparatus 10, including the blade assembly 12 and the individual blades 13, there includes a mechanism for securement 14. The handle 16, with its grip 18 and foot 20 are illustrated from the various orthogonal view points.

In operation, an apparatus 10 in accordance with the invention may typically be used in a pushing motion. To a certain extent, the edges 30 traveling along a surface operate according to the laws of friction. The fundamental controlling equation for friction states that the normal (perpendicular) force applied against or between two surfaces multiplied by the frictional coefficient characteristic of the materials of those two surfaces, equals the frictional force resisting relative motion between the surfaces. Accordingly, no relationship or combination for surface area appears in the equation.

Therefore, the net force applied by a user to the handle 16 controls the friction of the edges 30 together along the surface of the painted material being scraped. To the extent that one edge 30a, for example, receives more load than another edge 30c, the friction coefficient can at most act with the total normal force applied by and to the apparatus 10. The area applied to the surface is not a relevant factor. Thus, an apparatus 10 in accordance with the invention should not increase frictional resistance for a user. Thus, no additional energy need be expended on the basis of friction. Therefore, the additional edges 30 at work costs no frictional penalty.

Nevertheless, to a certain extent, the edges 30 may cut in under material and strip it away from the surface being scraped. To that extent, the force is not frictional force, but simply the shear force of the material. Accordingly, the sharpness of each edge 30 will have a direct relevance to cutting into material being scraped, while the peel strength of the material being peeled away will affect how much force is required to scrape.

Surface texturing and variations in height may limit the effectiveness of a blade. As a practical matter, it has been found that the use of multiple blades 13, and specifically of the multiple edges 30 working on a surface simultaneously, appear to have the benefit of capturing with each subsequent blade 30 portions of the underlying material that may have been missed due to a previous blade 30 riding up on debris, hard portions, or the like.

For example, a rise or ridge on a surface may cause a leading blade 30 to ride up on that ridge, leaving almost nothing else scraped. In one embodiment of an apparatus 10 in accordance with the invention, the leading blade may take down a portion of that ridge, while the subsequent blades 30 take off other layers, and potentially reach the face surface. Thus, it has been found that each of the blades 13, and each of the edges 30 will collect ahead of themselves the chips and debris scraped by that blade. It has been found that each of the blades actually contributes to the scraping. Thus, with no additional frictional penalty, the energy input goes directly to peeling the undesirable layers away from the underlying layer being prepared for repainting.

Likewise, it has been found that a suitable spacing of from about ⅛ to about ¼ inch between each of the edges 30 and its adjacent edges 30 is suitable to easily clear debris therefrom. At spacings less than ⅛ inch horizontally between the edges 30, it has been found that debris sometimes tends to collect. Likewise, the apparatus 10 may be made with blade assemblies 12 that provide greater than ¼ inch distance between the edges 30.

Wider spacing may create issues of strength, stabilization, vibrational chatter of the blades 13, and the like. Nevertheless, wider spacings do serve. Thus, in general, between about ⅛ and ⅜ of an inch of a gap horizontally between the edges, or between the extensions 31 may be suitable.

Meanwhile, an offset thickness of from about 1/16 to about ¼ inch may be used as the offset in the direction parallel to the extension 31. Typically, the offset in the direction of the extensions 31, or the plane thereof, may be selected according to the angle a user desires to hold the handle 16. For example, less difference in length (the offset between the various edges 30) results in a more flat trajectory in the horizontal direction. Greater offset distance results in a higher angle of the handle 16 with respect to the operating plane defined by the three edges 30.

In certain embodiments of an apparatus 10 in accordance with the invention, the overall blade assembly 12 may have a total length from the outermost edges 30 of from about 2 to about 4 inches. Typically, a length of about 2½ inches has been found quite satisfactory. Meanwhile, the blades may have a width from about 1 inch to about 4 inches wide. Typically, for clapboard for houses, it has been found that a width of from about 1½ to about 3 inches is suitable. A width of approximately 2 inches has been found quite suitable.

Meanwhile, the aperture 40 may be from about ¼ inch to about ½ inch diameter. In one embodiment, an aperture of about 3/8 inch with a lobe 42 interfering with its adjacent neighbor lobe 42 by about ⅛ inch provides about ¼ inch of horizontal offset between the edges 30 in a horizontal direction. Meanwhile, the apertures 28 or the registration apertures 38 may be circular or rectangular, or any other suitable shape. In one embodiment, the apertures may be from about ⅛ to about ½ inch. In one embodiment, approximately ½ inch has proven suitable as an outer dimension of diameter or effective diameter (side length) for a registration aperture 38.

In certain embodiments, the blades may be as thin as 1/32 inch. In other embodiments, the blades may be as thick as ⅛ inch each. If the blades are made in the embodiment of FIG. 3, it has been determined that a thickness of about 1/32 inch may be suitable. Nevertheless, so long as a suitable, chisel-type point is made by grinding the blades 13, the blades 13 may be of a greater thickness.

One advantage of thinner blades is flexibility, such that one blade 13 may deflect, and thus the three edges 30 may actually move out of plane with one another and provide additional scraping motion. Thus, the space between blades13, may suitably be set at from about ⅛ to about ⅜ inches. It has been found that more than about ⅛ inch and less than about ¼ inch is a completely suitable range in practice.

In one embodiment, blades may be from between about 1/32 inch to about ⅛ inch in thickness. A thickness of between 1/32 and ⅛ inch may suitably be set at about 1/16 inch to provide for suitable stiffness and strength, with suitable flexibility. It has been found that an offset of 3/16 inch between the blades in a horizontal direction when using a blade assembly 12 comprising three 1/16-inch-thick blades has been found suitable. In certain embodiments, either the corner 29 or an opposite end lacking any edge 30 may be used as a registration location to fit against the heel 26 of the foot 20.

It has been found that the edges 30 may be offset in the plane of the extension 31 (e.g., parallel to the plane of the extension 31) by a distance of from about 1/16 to about ¼ inch. In one embodiment, an offset between edges of about ⅛ inch has proven quite serviceable. This provides a net angle 48 comfortable for pushing the scraper while keeping the hands above and away from the surface being scraped.

In some embodiments, the widths of the blades 13 may be set at different values. For example, in certain embodiments, it has been found that for the embodiment of FIG. 3, the edge 30c may extend only ¼ inch below the base 28. By the same token, the blade 13 closest to the foot 20 may be the shortest, or rather have the shortest extension 31. If that extension extends only ¼ inch to the corresponding edge 30, then the next blade in the center may extend an additional ⅛ inch further, with the final and closest to the work piece being approximately ¼ inch taller, and thus about ½ inch tall.

Thus, in certain embodiments, it may be preferable to make blades 13 of various heights. In other embodiments, a combination of blade thickness and spacers may provide the difference in height, with each blade 13, as illustrated in FIG. 4 having exactly the same dimensions. Nevertheless, it has been found that an offset of from about 1/16 to about ¼ inch in the height of each edge 30 relative to its adjacent edges may be appropriate. About ⅛ inch has been found quite suitable in practice.

The blades 13 may have different widths along the lengths of their edges 30. Moreover, the distance between edges on a single blade may vary, according to the various angles with which each extension 31 may be fixed with respect to its base 28. In the embodiment of FIG. 4, all the extensions 31 extend at the same angle with respect to the base 28. In the embodiment of FIG. 3, the three extensions 31 may each have their own specific angle formed with their respective bases 28. Thus, in one embodiment it has been found that a maximum length from one edge to an opposite on a single blade 13 may be from about 1 to about 3 inches.

It has been found suitable to form a practical apparatus in which the maximum distance from one edge 32 to the opposite edge 30 of a single blade 13 may be about 2½ inches, and more specifically about 2 7/16 inch. Meanwhile, it has been found suitable to make the shortest blade 13 have a total length from one edge to an opposite edge of from about 1½ to about 2 inches, and one suitable embodiment has a total length of 1⅝ inches.

The present invention may be embodied in other specific forms without departing from its spirit or essential characteristics. The described embodiments are to be considered in all respects only as illustrative, and not restrictive. The scope of the invention is, therefore, indicated by the appended claims, rather than by the foregoing description. All changes which come within the meaning and range of equivalency of the claims are to be embraced within their scope.

What is claimed and desired to be secured by United States Letters Patent is:

1. A method for scraping paint comprising:
providing a plurality of blades comprising first, second, and third, blades having respective first, second, and third edges corresponding thereto;
providing a handle adapted to be gripped by a user;
providing a securement;
securing the first, second, and third blades to one another and the handle by the securement;
selecting a painted surface;
setting the first, second, and third blades on the surface substantially simultaneously;
applying pressure to the first second and third blades by applying force to the handle normal to the painted surface;
pushing the handle along the direction of the painted surface;
lifting by each of the first, second, and third blades simultaneously a respective portion of paint from the painted surface.

2. The method of claim 1, wherein the blades are each provided with a base and an extension angled away from the base.

3. The method of claim 2, wherein the edge of each blade is formed on the extension.

4. The method of claim 3, wherein the blades are substantially identical.

5. The method of claim 3, wherein the bases are parallel and adjacent one another.

6. The method of claim 5, wherein the extensions are spaced apart from one another.

7. The method of claim 6, wherein the extensions are parallel to one another.

8. The method of claim 7, wherein each blade comprises a second extension, opposite the first extension, having a second edge thereon.

9. The method of claim 1, further comprising releasing at least one of the first, second, and third blades, reversing the orientation thereof, and re-securing it to the handle to expose another edge in place of the edge thereof.

10. The method of claim 9, further comprising placing one of the first, second, and third blades in place of one of the others thereof, and re-securing the first second and third blades to the handle in a new order with respect to one another.

11. A method for scraping paint comprising:
providing a plurality of blades, each having a respective edge corresponding thereto;
providing a handle gripped by a user;
securing the plurality of blades to one another and the handle;
selecting a surface;
setting the plurality of blades in contact with the surface substantially simultaneously;
applying, normal to the painted surface, pressure to the plurality of blades;
pushing the handle along the surface;
lifting simultaneously, by each blade of the plurality of blades, a respective portion of paint from the surface.

12. The method of claim 11, wherein each blade of the plurality of blades is provided with a base and an extension, angled away from the base.

13. The method of claim 11, wherein:
the plurality of blades comprises more than two blades; and
the edge of each blade is formed to have a base parallel to a portion of the handle and an extension, angled with respect to the base, and extending to the respective edge thereof.

14. The method of claim 11, wherein the blades are substantially identical.

15. The method of claim 11, wherein each of the blades has a base and the bases are parallel and adjacent one another.

16. The method of claim 11, wherein each of the blades of the plurality of blades is symmetrical to be reversible, presenting another edge in place of the edge thereof.

17. The method of claim 11, wherein each blade of the plurality of blades includes an extension extending away from and non-parallel with respect to a base thereof secured to the handle, the extensions being spaced apart and substantially parallel to one another.

18. The method of claim 17, wherein each blade comprises a second extension, opposite the first extension, having a second edge thereon.

19. The method of claim 1, wherein each blade has another edge opposite the edge, the method further comprising releasing at least one blade of the plurality of blades, reversing the orientation thereof to place the other edge in an operable position, and re-securing the at least one blade.

20. A method for scraping paint comprising:
providing a plurality of blades, each provided with a base at each end thereof and an extension angled away from the base to terminate at a respective edge corresponding to the extension;
providing a handle gripped by a user;
securing the plurality of blades to one another and to the handle with the bases parallel and adjacent one another, the extensions being substantially parallel to and spaced apart from each other;
selecting a surface;
setting the plurality of blades in contact with the surface substantially simultaneously;
applying, normal to the painted surface, pressure to the plurality of blades;
pushing the handle along the surface;
releasing at least one blade of the plurality of blades, reversing the orientation thereof, and re-securing the at least one blade to the handle, thereby exposing another edge in place of the edge thereof; and
lifting simultaneously, by each blade of the plurality of blades, another respective portion of paint from the surface.
